(19) United States
(12) Patent Application Publication
(10) Pub. No.: US 2022/0023699 A1
(43) Pub. Date: Jan. 27, 2022

(54) COMBINATION PET LEASH AND EXERCISE APPARATUS

(71) Applicant: Brandon Travis Currie, Courtenay (CA)

(72) Inventor: Brandon Travis Currie, Courtenay (CA)

(21) Appl. No.: 17/443,045

(22) Filed: Jul. 20, 2021

Related U.S. Application Data
(60) Provisional application No. 63/054,487, filed on Jul. 21, 2020.

(51) Int. Cl. A63B 21/055; A01K 27/00

(52) U.S. Cl. CPC A63B 21/0557; A01K 27/003

(57) ABSTRACT

A combination pet leash and exercise apparatus that is configured to be utilized in a first configuration and a second configuration. In the first configuration the present invention is utilized to walk a pet. In the second configuration the present invention provides a resistance exercise for the user. A first member and a second member are adjacent to each other and releasably secured in the first configuration. The first member is a nylon strap and the second member is an elastic tube. Fasteners are present at each end of the first member and second member and are secured to ring members in the first configuration. A handle member is secured to the first ends of the first member and second member in the first configuration. In the second configuration handle member is released from operable engagement with the first member so as to be only coupled to the second member.

### PRIORITY UNDER 35 U.S.C SECTION 119(E) & 37 C.F.R. SECTION 1.78

This nonprovisional application claims priority based upon the following prior United States Provisional Patent application entitled: Combination Pet Leash and Personal Training Apparatus, Application No.: 63/054,487 filed Jul. 21, 2020, in the name of Brandon Travis Currie, which is hereby incorporated by reference for all purposes.

### FIELD OF THE INVENTION

The present invention relates generally to pet leashes, more specifically but not by way of limitation, a pet leash having a first member and a second member wherein the second member is manufactured from an elastic band material and is configured to be separated at one end for use thereof by a user to execute resistance type exercise movements.

### BACKGROUND

Millions of individuals own dogs across North America. These dog owners will routinely engage in various activities to regularly exercise the dog as part of the recommended hygiene and care program for the dog. Dog owners will often go on walks with their pets to a park or other location. It is typically required or desirable that the dog will have a leash attached to the dog in order to provide safety both for the dog and for others in the vicinity. The dog owners if available may walk there dog to a dog park, otherwise known as a dog run, which is an enclosed space that allows the pet to safely run free without a leash attached.

While dog parks and runs are sometimes available, there are locations where these types of facilities are not available. When these facilities are not available the dog owner will most often have to maintain the leash engaged with the dog. While walking the dog does provide an exercise benefit for the dog owner, there are many dog owners that desire to perform other types of exercise while walking their dog such as but not limited to resistance type exercises. This is typically not achievable unless the dog owner were to carry an additional apparatus which is not convenient when managing a dog on a leash.

Accordingly, there is a need for a pet leash that provides the ability for the pet owner to execute resistance exercises wherein the pet leash of the present invention includes a first member and a second member that configured to be separate and wherein the second member is operable to provide resistance type exercises for a user.

### SUMMARY OF THE INVENTION

It is the object of the present invention to provide a combination pet leash and exercise apparatus that is configured to maintain control of a pet and further provide resistance type exercises for a user that includes a first member and a second member.

Another object of the present invention is to provide a pet leash and resistance exercise apparatus wherein the first member and second member include a first end and a second end.

A further object of the present invention is to provide a combination pet leash and exercise apparatus that is configured to maintain control of a pet and further provide resistance type exercises for a user wherein the first member includes fasteners on the first end and second end.

Still another object of the present invention is to provide a pet leash and resistance exercise apparatus wherein the first end of the first member includes a handle secured thereto and wherein the handle includes a loop member.

An additional object of the present invention is to provide a combination pet leash and exercise apparatus that is configured to maintain control of a pet and further provide resistance type exercises for a user wherein the second member is operably coupled to a first fastener at the first end of the second member.

Yet a further object of the present invention is to provide a pet leash and resistance exercise apparatus wherein the second member includes a second fastener coupled to the second end thereof.

Another object of the present invention is to provide a combination pet leash and exercise apparatus that is configured to maintain control of a pet and further provide resistance type exercises for a user wherein the first member includes a swivel hook member secured to the second end thereof.

Still a further object of the present invention is to provide a pet leash and resistance exercise apparatus wherein the second member is manufactured from elastic band material.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention; and

FIG. 2 is a perspective view of the present invention with the invention illustrated configured for use to execute resistance exercises.

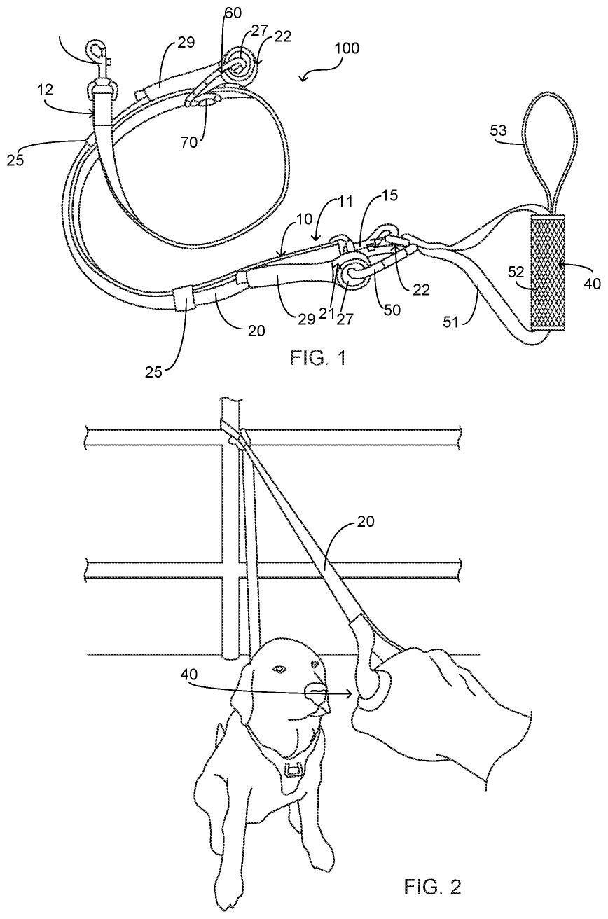

### DETAILED DESCRIPTION

Referring now to the drawings submitted herewith, wherein various elements depicted therein are not necessarily drawn to scale and wherein through the views and figures like elements are referenced with identical reference numerals, there is illustrated a pet leash and exercise apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to Figures submitted as a part hereof, the pet leash and exercise apparatus 100 includes a first member 10 and a second member 20. The first member 10 includes a first end 11 and a second end 12. First member 10 is manufactured from a suitable durable material such as but not limited to nylon. It should be understood within the scope of the present invention that the first member 10 could be provided in alternate lengths. The first member 10 includes a first swivel hook 15 secured to the first end 11. A second swivel hook 16 is secured to the second end 12 of the first member 10. Both the first swivel hook 15 and second swivel hook 16 are conventional swivel hooks and are secured utilizing suitable techniques. While swivel hooks are taught in the preferred embodiment, it is contemplated within the scope of the present invention that the pet leash and exercise apparatus 100 could employ alternate types of fasteners in place of the swivel hooks to accomplish the desired objective. The second swivel hook 16 is configured to be secured to a dog collar. The first swivel hook 15 is secured to ring member 22. The first swivel hook 15 is released from the ring member 22 when the user of the pet leash and exercise apparatus 100 desires to utilize the second member 20 to execute resistance exercises as is further discussed herein. The first member 10 and second member 20 are releasably secured to be adjacent to each other in the first position of the pet leash and exercise apparatus 100. The first member 10 and second member 20 are releasably secured utilizing straps 25. Straps 25 are manufactured from material such as but not limited to nylon and include hook and loop material or other suitable fasteners to facilitate the surroundable mounting and securing of the first member 10 and second member 20. It is contemplated within the scope of the present invention that the pet leash and exercise apparatus 100 could employ as few as one strap 25 or more than two straps 25 to achieve the desired objective stated herein.

A handle member 40 is secured to the ring member 22 and first fastener 50. The handle member 40 includes a strap portion 51 and grip member 52 and is utilized when a user of the pet leash and exercise apparatus 100 has the pet leash and exercise apparatus 100 operably coupled to a pet so as to facilitate controlling and walking of the pet. The handle member 40 includes loop member 53 wherein the loop member 53 is secured to the grip member 52 utilizing suitable techniques. The loop member 53 provides an ability for a user to place their hand and wrist thereinto so as to offer a safety element in the event the user becomes disengaged with the grip member 52 and in such an event still maintain control of the pet leash and exercise apparatus 100 and any pet operably coupled thereto. It is contemplated within the scope of the present invention that the loop member 53 could be manufactured from alternate materials and provided in various sizes.

The second member 20 includes a first end 21 and a second end 22. First end 21 and second end 22 include eyelets 27 formed from a durable rigid material such as but not limited to plastic. The eyelets 27 are surroundably mounted by end portions of the second member 20 and secured using wrapping 29. It is contemplated within the scope of the present invention that the second member 20 could have alternate configurations at the first end 21 and second end 22 in place of and/or in conjunction with the eyelets 27. The second member 20 has a second fastener 60 secured to the second end 22. A second ring member 70 is also secured to the second end 22 of the second member 20. In its second position the pet leash and exercise apparatus 100 is operably engaged with a suitable anchoring element such as but not limited to a pole. In this configuration as is illustrated herein in FIG. 2, the second swivel hook 16 is coupled to second ring member 70 so as to encircle the anchoring element in order to allow a user of the pet leash and exercise apparatus 100 to utilize the second member 20 to execute resistance exercises. The second member 20 is manufactured from an elastic band and as such is stretchable from its relaxed state. In the second configuration, the first swivel hook 15 and straps 25 are released and as such the second member 20 can be independently moved and utilized. The handle member 40 is operably coupled to the first fastener 50 in the second configuration of the pet leash and exercise apparatus 100 and allows a user to employ a force on the second member 20 wherein the second member 20 will stretch and during this motion will provide resistance. It should be understood within the scope of the present invention that the second member 20 could be utilized to perform various types of exercise movements and provide resistance for the user.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A combination pet leash and exercise apparatus comprising:
a first member, said first member being elongated in form, said first member having a first end and a second end, said first member having a first coupling present at said first end, said first end having a second coupling at said second end,
a second member, said second member being adjacent said first member, said second member having a first end and a second end, said second member being releasably secured to said first member in a first configuration of the pet leash and exercise apparatus, said second member being manufactured from an elastic material;
a handle member, said handle member being operably coupled to said first end of said first member and said first end of said second member in the first configuration of the pet leash and exercise apparatus; and
wherein in a second configuration of the pet leash and exercise apparatus the first end of the first member is disengaged from the handle member.

2. The combination pet leash and exercise apparatus as recited in claim 1, and further including at least one strap member, said at least one strap member configured to be circumferentially disposed said first member and said second member in the first configuration of the pet leash and exercise apparatus.

3. The combination pet leash and exercise apparatus as recited in claim 2, and further including a first ring member, said first coupling being secured to said first ring member.

4. The combination pet leash and exercise apparatus as recited in claim 3, and further including a first fastener, said first fastener being secured to said first end of said second member and said first ring member in the first configuration.

5. The combination pet leash and exercise apparatus as recited in claim 4, wherein in said second configuration, said first coupling is disengaged from said first ring member.

6. The combination pet leash and exercise apparatus as recited in claim 5, and further including a second ring member, said second ring member being secured to said second end of said first member.

7. The combination pet leash and exercise apparatus as recited in claim 6, wherein said first coupling and said second coupling are swivel hooks.

8. The combination pet leash and exercise apparatus as recited in claim 7, wherein said second member is manufactured from elastic tubing.

9. The combination pet leash and exercise apparatus as recited in claim 8, and further including a second fastener, said second fastener being secured to said second end of said second member and said second ring member in the first configuration.
